(19) United States
(12) Patent Application Publication
(10) Pub. No.: US 2012/0005107 A1
(43) Pub. Date: Jan. 5, 2012

(54) System and Method for Monitoring Equipment Maintenance

(76) Inventors: James J. Lowden, Madison, WI (US); Jerome Slattery, Middleton, WI (US)

(21) Appl. No.: 12/829,966

(22) Filed: Jul. 2, 2010

(51) Int. Cl. G06Q 10/00

(52) U.S. Cl. 705/305

(57) ABSTRACT

A method comprises storing maintenance data associated with a particular maintenance task for a particular type of equipment, where the maintenance data includes calendar maintenance data and usage maintenance data. The method further comprises storing calendar tracking data and usage tracking data. The method further comprises determining if the calendar tracking data equals or exceeds a first predetermined threshold associated with the calendar maintenance data, determining if the usage tracking data equals or exceeds a second predetermined threshold associated with the usage maintenance data, and in response to either the first or the second predetermined thresholds being met, generating an alert associated with the maintenance task for the instance of the particular type of equipment that has been deployed.

### TECHNICAL FIELD OF THE DISCLOSURE

This disclosure relates in general to maintaining equipment and, more particularly, to monitoring equipment maintenance.

### BACKGROUND

As organizations use more types of equipment, performing the proper maintenance tasks for the equipment at the proper times becomes increasingly difficult. A person associated with an organization may not be aware of the proper maintenance tasks for each type of equipment. Even if a person associated with the organization is aware of the proper maintenance tasks for each type of equipment, it becomes increasingly complicated for the person to determine when particular maintenance tasks should be performed for each particular piece of equipment. Various components of equipment may have different maintenance schedules and each type of equipment may have maintenance tasks recorded in separate instruction manuals. As a result, maintenance tasks of equipment may never occur or may not occur timely, which may cause the equipment to break or perform poorly. As organizations use more types of equipment, traditional equipment maintenance procedures are unable to effectively notify a person associated with the organization when to perform particular maintenance tasks for particular pieces of equipment.

### SUMMARY

In accordance with the present disclosure, the disadvantages and problems associated with prior systems and methods of equipment maintenance have been substantially reduced or eliminated.

In some embodiments, a method for equipment maintenance, comprises storing a plurality of maintenance tasks for a particular type of equipment. The method further comprises, for a particular maintenance task of a particular type of equipment, storing maintenance data that comprises at least one of calendar maintenance data that is associated with a first period of time since the particular maintenance task was last performed, and usage maintenance data that is associated with a second period of time that the particular type of equipment has been in use since the particular maintenance task was last performed. The method further comprises storing tracking data associated with the particular maintenance task for an instance of the particular type of equipment that has been deployed. The tracking data comprises at least one of calendar tracking data associated with an accumulated time since the particular maintenance task of the instance of the particular type of equipment was last performed and usage tracking data associated with an accumulated time that the instance of the particular type of equipment has been in use since the particular maintenance task was last performed. The method further comprises performing at least one of determining if the calendar tracking data equals or exceeds a first predetermined threshold associated with the calendar maintenance data and determining if the usage tracking data equals or exceeds a second predetermined threshold associated with the usage maintenance data. The method further comprises, in response to either the first or the second predetermined threshold being met, generating an alert associated with the maintenance task for the instance of the particular type of equipment that has been deployed.

The present disclosure provides several important technical advantages. One advantage is that a maintenance system may provide a central location for storing each recommended maintenance task for each particular instance of equipment that has been deployed. Another advantage is that a maintenance system may provide an intelligent display of maintenance information to the user for each particular instance of equipment that has been deployed. Another advantage is that the system may automatically notify one or more users when to perform each maintenance task for each particular instance of equipment that has been deployed. As a result, users may not need to spend time checking separate manuals for each type of equipment to determine when to perform a particular maintenance task. By performing the recommended maintenance tasks at the recommended time intervals, the equipment may last longer and perform better, which may increase profits and decrease costs associated with fixing broken equipment or buying replacement equipment. The maintenance system may decrease the chance of equipment failure, which may increase safety and performance of the users or animals associated with the system.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates a system for monitoring equipment maintenance, according to certain embodiments;

FIG. 2 illustrates an example Graphical User Interface (“GUI”) that assists a user in monitoring equipment maintenance, according to certain embodiments;

FIG. 3 illustrates a table comprising example maintenance data for monitoring equipment maintenance, according to certain embodiments;

FIG. 4 illustrates a table comprising example tracking data for monitoring equipment maintenance, according to certain embodiments; and

FIG. 5 illustrates a flow diagram for monitoring equipment maintenance, according to certain embodiments.

### DETAILED DESCRIPTION

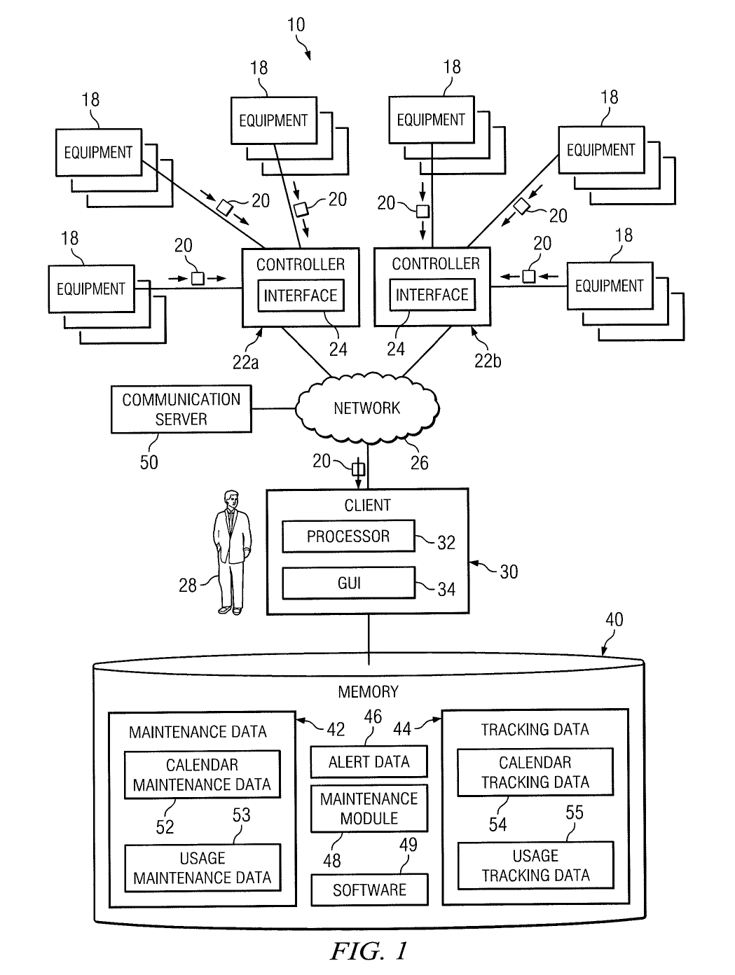

FIG. 1 illustrates a system 10 for monitoring equipment maintenance, according to certain embodiments. Generally, system 10 may monitor the usage of equipment 18, compare the usage of equipment 18 against recommended schedules for performing maintenance of equipment 18, and alerting users 28 when to perform maintenance of equipment 18. System 10 may include equipment 18, one or more controllers 22, one or more networks 26, one or more clients 30 operated by one or more users 28, and a memory 40. For purposes of explanation, examples describing system 10 may generally be associated with a dairy farm. However, system 10 may be associated with any industry where equipment maintenance is needed. For example, system 10 may be associated with slaughterhouses, processing, manufacturing, distribution, etc.

Equipment 18 may represent an instance of a particular type of machine, component, device, or any combination thereof that has been deployed. In some embodiments, equipment 18 may be associated with a dairy farm. Equipment 18 may be associated with industries other than dairy, including slaughterhouses, processing, manufacturing, shipping, etc. Non-limiting examples of particular types of equipment 18 in the dairy industry may include a controller, vacuum system, pulsation system, oil reclaimer, oil vane vacuum pump, lobe vacuum pump, milk transport system, milk unit, milk sensor, cleaning system, washer, milk cooling system, chemical dispensing unit, condensing unit, heat recovery unit, chiller system, milk meter, detacher assembly, identification system of animals, parlor stall system, and crowd gate.

System 10 may deploy numerous types of equipment 18, including numerous instances of each type of equipment 18. Further, a particular type of equipment 18 may have numerous model numbers and may be manufactured by different sources. The maintenance tasks and the recommended time period for performing the maintenance tasks for each instance of equipment 18 deployed in system 10 may vary depending on the type, model number, and/or manufacturer of equipment 18. As described below, system 10 may be used to track the use of a particular instance of equipment 18 against the recommended time period for performing each maintenance task for the particular instance of equipment 18.

Equipment 18 may be operable to communicate usage data 20 associated with the time of use of equipment 18. Equipment 18 may communicate usage data 20 to controller 22, and subsequently to client 30 for storage in memory 40. Usage data 20 of equipment 18 may be represented in any suitable manner. For example, usage data 20 from a particular instance of equipment 18 may comprise an identification of the particular instance of equipment 18, start time of usage, stop time of usage, duration of usage, etc. Units of time may be represented in any suitable manner. For example, units of time may be represented as years, months, days, hours, minutes, seconds, etc., as appropriate for particular equipment 18. As shown in FIG. 1, equipment 18 may be located in any number of locations, and system 10 may operate across multiple locations or in a single location.

Controller 22 may communicate with equipment 18 to track the time of use associated with each instance of equipment 18. Controller 22 may be any suitable computing device comprising a processor and a memory. For example, controller 22 may comprise one or more machines, workstations, laptops, blade servers, server farms, and/or stand alone servers. Although shown in FIG. 1 as comprising two components, controller 22 may, in some embodiments, represent functionality provided by one or more separate physical components. Controller 22 may include software operating on one or more devices. Particular embodiments of system 10 may include any appropriate number of controllers 22 arranged in any suitable configuration. For example, controller 22a may be associated with dairy farm ABC and controller 22b may be associated with dairy farm XYZ. Each respective controller 22 may be operable to communicate, directly or indirectly, with one or more particular instances of equipment 18, other controllers 22, or clients 30 over network 26. Although shown in FIG. 1 as being remote from equipment 18, controller 22 may, in some embodiments, be integrated with equipment 18.

Controller 22 may include one or more interfaces 24 that may receive input, send output, process the input and/or output, and/or perform other suitable operations for the elements illustrated in FIG. 1. Interfaces 24 may include any hardware and/or controlling logic used to communicate information to and from one or more elements illustrated in FIG. 1. For example, controller 22 may be operable to receive and process data from different types or models of equipment 18 that may transmit different protocols or formats. Although not illustrated, other elements in FIG. 1 (e.g., client 30) may also comprise one or more interfaces 24 to communicate information to and from one or more elements illustrated in FIG. 1.

System 10 may use network 26 to send usage data 20 of equipment 18 to a central location (or a number of distributed locations), even though equipment 18 may be located at one or more remote locations. Network 26 may represent any form of communication network supporting circuit-switched, packet-based, and/or any other suitable type of wireline or wireless communications. Network 26 may additionally include any other components of system 10 capable of transmitting and/or receiving information over a communication network, including equipment 18, controllers 22, clients 30, and/or communication server 50. Although shown in FIG. 1 as a single element, network 26 may represent one or more separate networks (including all or parts of various different networks) that are separated and serve different respective elements illustrated in FIG. 1. Network 26 may include routers, hubs, switches, firewalls, content switches, gateways, call controllers, and/or any other suitable components in any suitable form or arrangement. Network 26 may include, in whole or in part, one or more secured and/or encrypted Virtual Private Networks (VPNs) operable to couple one or more network elements together by operating or communicating over elements of a public or external communication network. In general, network 26 may comprise any combination of public or private communication equipment such as elements of the public switched telephone network (PSTN), a global computer network such as the Internet, a local area network (LAN), a wide area network (WAN), or other appropriate communication equipment.

Users 28 may interact with equipment 18 and/or clients 30. Users 28 may be actual users of equipment 18, owners of equipment 18, or dealers of equipment 18. Client 30 may receive usage data 20 associated with particular instances of equipment 18 and generate alerts associated with particular maintenance tasks for particular instances of equipment 18 to one or more users 28. Client 30 may display data associated with maintenance tasks on a display device.

Client 30 may allow users 28 to monitor the maintenance of numerous instances and types of equipment 18 from one or more specific locations remote from the location of equipment 18. Clients 30 may represent general or special-purpose computers operating software applications capable of performing the described operations. For example, clients 30 may include, but are not limited to, laptop computers, desktop computers, and/or portable data assistants (PDAs). Additionally, in particular embodiments, client 30 may include one or more processors 32 operable to execute computer logic and/or software 49 encoded on tangible media that perform the described functionality. Client 30 may include one or more input devices such as a keyboard, trackball, mouse, and/or one or more Graphical User Interfaces (GUIs) 34 through which user 28 may interact with the logic executing on the processor 32 of client 30. Client 30 may include any appropriate combination of hardware, software 49, and/or encoded logic suitable to perform the described functionality. Clients 30 may be communicatively coupled with equipment 18, controllers 22, memory 40, and/or communication server 50, directly or indirectly, over network 26. System 10 may comprise any appropriate number and type of clients 30.

Client 30 may use a processor 32 to run software 49 responsible for monitoring the maintenance of equipment 18. Processor 32 may represent and/or include any form of processing component, including general purpose computers, dedicated microprocessors, or other processing devices capable of processing electronic information. Examples of processor 32 include digital signal processors (DSPs), application-specific integrated circuits (ASICs), field-programmable gate arrays (FPGAs), and any other suitable specific or general purpose processors. Although FIG. 1 illustrates a single processor 32 in client 30, client 30 may include any suitable number and combination of processors 32.

Client 30 may display GUI 34 to user 28. GUI 34 may display information regarding maintenance tasks for one or more particular instances of equipment 18. Non-limiting examples of information displayed in GUI 34 may include a description for each maintenance task for each instance of equipment 18; the projected time when each maintenance task should be performed; the time remaining until a particular maintenance task is recommended for a particular instance of equipment 18; the accumulated time each instance of each type of equipment 18 has been in use since each particular maintenance task was last performed; the accumulated time that a particular maintenance task was last performed for each instance of each type of equipment 18; the costs associated with each maintenance task; and a percentage value representing how close in time each maintenance task should be performed by users 28. In some embodiments, information displayed in GUI 34 may not occur until user 28 clicks or mouses over an area of GUI 34. In some embodiments, display of particular instances of equipment 18 may be grouped by category. For example, equipment 18 may be grouped by location, type of equipment 18, or by equipment 18 associated with a particular system (e.g., vacuum system). As a result, users 28 may quickly and effectively locate particular instances of equipment 18 of interest.

Processor 32 may be communicatively coupled to memory 40. Memory 40 may comprise any collection and arrangement of volatile and/or non-volatile components suitable for storing data. For example, memory 40 may comprise random access memory (RAM) devices, read only memory (ROM) devices, magnetic storage devices, optical storage devices, and/or any other suitable data storage devices. Memory 40 may represent, in part, computer-readable storage media on which computer instructions and/or logic are encoded. Some or all the described functionality of maintenance module 48 described below may be provided by processor 32 executing the instructions encoded on the described media. Although shown in FIG. 1 as a single component, memory 40 may represent any number of memory components within, local to, and/or accessible by processor 32. Memory 40 may represent storage components remote from client 30 such as, for example, components of a Network Attached Storage (NAS), Storage Area Network (SAN), or any other type of remote storage system. In some embodiments, memory 40 may represent storage components internal to client 30.

Memory 40 may store maintenance data 42, tracking data 44, alert data 46, maintenance module 48, software 49, and/or any other suitable information, including, but not limited to data associated with one or more instances of equipment 18 that have been deployed, the location of one or more instances of equipment 18, data regarding maintenance tasks associated with one or more particular types of equipment 18, the cost of each maintenance task, and the date associated with when user 28 performed one or more maintenance tasks for one or more instances of equipment 18. Memory 40 may store one or more maintenance tasks for one or more types of equipment 18. Memory 40 may store one or more types of equipment into a particular grouping. For example, all equipment 18 associated with the vacuum system may be stored in a grouping associated with a vacuum system. Certain data stored in memory 40 may be predetermined by software 49 installed on client 30. By storing the same maintenance tasks and maintenance data 42 for each particular type of equipment 18, users 28 may perform the recommended maintenance for each particular type of equipment 18 consistently and timely, which may improve performance and life of each particular instance of equipment 18 deployed in system 10. In some embodiments, user 28 may input data that modifies or replaces data stored in memory 40.

Maintenance data 42 may be any type of data useful in determining when and what type of particular maintenance task should be performed for a particular type of equipment 18. Maintenance data 42 may be represented by one or more values and stored in any suitable format. Maintenance data 42 may indicate a time period for recommending that a particular maintenance task be performed by user 28. For example, maintenance data 42 may indicate that the maintenance task for greasing a vacuum pump should be performed every 345 hours of use or every three months since the maintenance task was last performed. Non-limiting examples of a time period may include each day, every fifty hours, every 250 hours, every 1,500 hours, every 3,000 hours, weekly, monthly, six months, and yearly. Maintenance data 42 may indicate that a particular maintenance task should be recommended to be performed by user 28 upon the occurrence of an event. For example, maintenance data 42 may indicate that the vacuum filter on a vacuum system should be cleaned after every vacuum pump oil change.

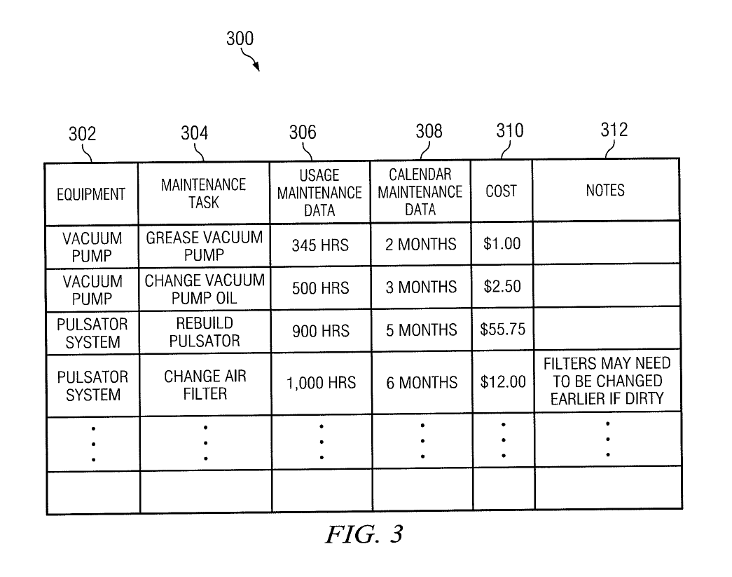

Maintenance data 42 may comprise calendar maintenance data 52 that may be associated with a period of time for recommending a particular maintenance task, where this period of time is associated with an accumulated time since the particular maintenance task was last performed. For example, calendar maintenance data 52 may indicate that the maintenance task for greasing a vacuum pump should be performed three months after the maintenance task was last performed. Maintenance data 42 may comprise usage maintenance data 53 that may be associated with a period of time for recommending a particular maintenance task, where this period of time is associated with an accumulated time that the particular type of equipment 18 has been in use since the particular maintenance task was last performed. For example, usage maintenance data 53 may indicate that the maintenance task for greasing a vacuum pump should be performed every 345 hours of use. In some embodiments, maintenance data 42 may be predetermined by software 49 installed on client 30. In some embodiments, user 28 may input data that modifies or replaces maintenance data 42 stored in memory 40. Maintenance data 42 may be stored in maintenance tables as described in more detail below in FIG. 3.

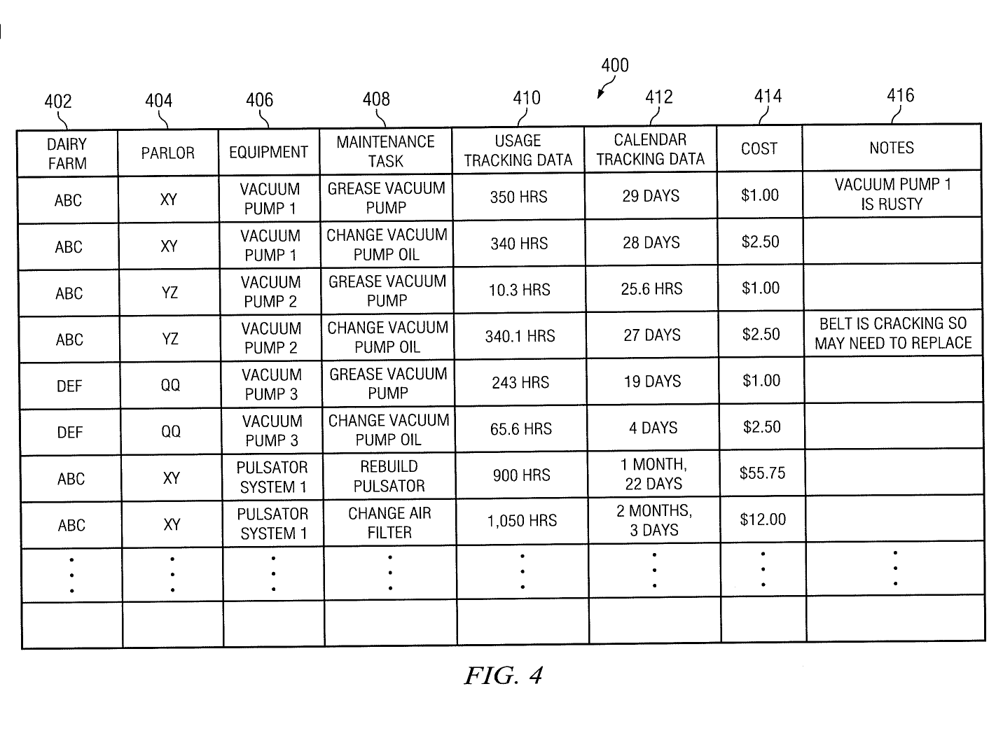

Tracking data 44 may be any type of data that is useful in determining when a particular maintenance task for a particular instance of equipment 18 should be performed. Tracking data 44 may be represented by one or more values and stored in any suitable format. Tracking data 44 may comprise calendar tracking data 54 that may be associated with an accumulated time since the particular maintenance task of the particular instance of equipment 18 was last performed. For example, calendar tracking data 54 may represent an accumulated time of two months since the maintenance task for greasing a particular vacuum pump was last performed. Tracking data 44 may be usage tracking data 55 that may be associated with an accumulated time that a particular instance of equipment 18 has been in use since a particular maintenance task was last performed. For example, usage tracking data 55 may represent an accumulated time of 240 hours of usage time since the maintenance task for greasing a particular vacuum pump was last performed. Usage tracking data 55 for a particular instance of equipment 18 may be an accumulation of usage data 20 received from the particular instance of equipment 18. For example, a particular instance of equipment 18 may communicate usage data 20 on a first day indicating that the particular instance of equipment 18 was in use for four hours during the first day and communicate usage data 20 on a second day indicating that the particular instance of equipment 18 was in use for nine hours during the second day. Thus, the usage tracking data 55 for this particular instance of equipment 18 may be thirteen hours, which represents an accumulation of usage data 20 during the first and second days. User 28 may input data that modifies or replaces tracking data 44 stored in memory 40. Tracking data 44 may be stored in tracking tables as described in more detail below in FIG. 4.

Alert data 46 may be any type of data that is useful to instruct a user 28 to perform a particular maintenance task for a particular instance of equipment 18 that has been deployed. For example, alert data 46 may instruct user 28 to grease a particular vacuum pump. Alert data 46 may comprise one or more values stored in any suitable format. For example, alert data 46 may include the part number and a hyperlink to buy a part or materials associated with the particular type of equipment 18 that is to be maintained. Alert data 46 may determine who is to receive the alert and with what frequency the alerts should be sent. For example, alert data 46 may include a list of contact names, addresses associated with the list of contact names, and frequency of alerts (e.g., per hour, per day, etc.). Alert data 46 may determine the method of delivery for the alert. For example, alert data 46 may indicate if alert should be persistently displayed in GUI 34, displayed at a particular instance of equipment 18, and/or sent via email, text message, and/or instant message (IM) to one or more users 28. Alert data 46 may be configurable to customize how and when alerts are sent based on any type of situation. For example, alert data 46 may indicate that a first user 28 should receive alerts associated with refrigeration equipment 18 and a second user 28 should receive alerts associated with vacuum equipment 18.

Maintenance module 48 may receive, process, and analyze usage data 20, maintenance data 42, tracking data 44, alert data 46, and any other data associated with monitoring, scheduling, notifying, and performing maintenance tasks for one or more instances of equipment 18 that have been deployed. Maintenance module 48 may determine usage tracking data 55 for a particular maintenance task associated with a particular instance of equipment 18 by accumulating the time the particular instance of equipment 18 has been in use since the particular maintenance task was last performed. Maintenance module 48 may determine calendar tracking data 54 for a particular maintenance task associated with a particular instance of equipment 18 by accumulating the time since the particular maintenance task was last performed for the particular instance of equipment 18.

Maintenance module 48 may automatically determine when maintenance should be recommended for each particular piece of equipment 18 based on calendar time or usage time associated with each particular piece of equipment 18. For example, maintenance module 48 may determine if calendar tracking data 54 associated with a particular maintenance task for a particular instance of equipment 18 equals or exceeds a predetermined threshold associated with calendar maintenance data 52. Similarly, maintenance module 48 may determine if usage tracking data 55 equals or exceeds a predetermined threshold associated with usage maintenance data 53. The predetermined threshold for recommending maintenance may be equal to, less than, or greater than the values associated with calendar maintenance data 52 or usage maintenance data 53. For example, the predetermined threshold may be a user defined percentage (e.g., 85%, 100%, 125%, etc.) of calendar maintenance data 52 or usage maintenance data 53. Based on the above determinations, maintenance module 48 may determine when and how to generate an alert associated with performing a particular maintenance task for a particular instance of equipment 18. For example, maintenance module 48 may generate an alert to a particular user 28 to recommend performing the maintenance task of greasing a particular instance of a vacuum pump in response to determining that the particular vacuum pump has been in use for 360 hours since the last time this maintenance task was performed, which is greater than a recommended time period of greasing that type of vacuum pump every 345 hours.

Maintenance module 48 may automatically determine one or more values that may be used to put users 28 on notice of upcoming maintenance tasks. For example, maintenance module 48 may determine the time remaining until a particular maintenance task is recommended for a particular instance of equipment 18. In another example, maintenance module 48 may determine a percentage representing how close in time a particular maintenance task for a particular instance of equipment 18 should be performed by user 28. Maintenance module 48 may also determine the projected time when a particular maintenance task should be performed for a particular instance of equipment 18 deployed in system 10. To determine the projected time, maintenance module 48 may determine an average time that a particular instance of equipment is used per day and assume this average time will be constant in the future to determine the projected time.

Communication server 50 may send and/or receive emails, text messages, instant messages, or other types of alerts generated by users 28 or maintenance module 48 within system 30 and may receive emails from any other source. In particular embodiments, communication server 50 may represent a Microsoft Exchange email server, a Unix-based server running a sendmail or Simple Mail Transfer Protocol application, and/or other appropriate type of server.

Each of equipment 18, controller 22, client 30, processor 32, memory 40, maintenance module 48, and communication server 50 may represent any appropriate combination of hardware and/or software 49 suitable to perform the described functions. Logic may be contained within hardware configuration or a combination of software 49 and hardware configurations. The logic may also be embedded within any other suitable medium without departing from the scope of the disclosure. The medium may include RAM, ROM, or disk drives. The medium may be non-transitory. For example, software 49 may be logic encoded on tangible, computer-readable media and executed on client 30 and/or other computer hardware suitable to provide the described functions of maintenance module 48.

In operation, a particular instance of equipment 18 in use may transmit usage data 20 associated with its period of use. Usage data 20 may comprise time stamps indicating a start and stop time. For example, a particular vacuum pump XYZ may transmit usage data 20 indicating its serial number and that it was in use on Apr. 1, 2010 from 4:10 p.m. to 5:42 p.m. One or more controllers 22 or one or more clients 30 may capture usage data 20 associated with the particular instance of equipment 18 in use. The one or more controllers 22 may transmit usage data 20 to the one or more clients 30.

Controller 22 may receive, process, analyze, and/or transmit usage data 20 associated with the use of particular instances of equipment 18. In an alternate embodiment, controller 22 may determine usage data 20 for particular instances of equipment 18 based on the time the particular instances of equipment 18 are scheduled to be in use, rather than the actual use of particular instances of equipment 18. Controller 22 may determine usage data 20 of particular instances of equipment 18 based on usage data 20 associated with other particular instance of equipment 18.

For example, controller 22 may determine the time of use of a vacuum system from data sent from the vacuum pump and associate this time of use with other instances of equipment 18 (e.g., pulsation system, oil reclaimer, vacuum regulator, etc.) even if these other instances of equipment 18 did not transmit usage data 20 to controller 22. Controller 22 may associate the usage data 20 for particular instances of equipment 18 based on predetermined usage data 20 for particular instances of equipment 18.

Maintenance module 48 may determine calendar tracking data 54 and usage tracking data 55 for a particular maintenance task associated with the particular instance of equipment 18. Maintenance module 48 may determine usage tracking data 55 for a particular maintenance task associated with a particular instance of equipment 18 by aggregating usage data 20 of the particular instance of equipment 18 has been in use since the particular maintenance task was last performed. For example, maintenance module 48 may accumulate usage data 20 associated with vacuum pump XYZ to determine that vacuum pump XYZ has been in use for 1,515 hours since the maintenance task of lubricating the drive and bearings of vacuum pump XYZ was last performed. Maintenance module 48 may determine calendar tracking data 54 for a particular maintenance task associated with a particular instance of equipment 18 by accumulating the time since the particular maintenance task was last performed for the particular instance of equipment 18. For example, maintenance module 48 may determine that it has been eleven months and three days since the maintenance task of lubricating the drive and bearings of vacuum pump XYZ was last performed.

Maintenance module 48 may automatically determine when maintenance should be recommended for each particular piece of equipment 18 based on calendar time or usage time or both. Maintenance module 48 may compare calendar tracking data 54 to calendar maintenance data 52 for a particular maintenance task for a particular instance of equipment 18 to determine if its calendar tracking data 54 equals or exceeds calendar maintenance data 52 for that particular type of equipment 18. For example, calendar maintenance data 52 for lubricating the drive and bearings of a vacuum pump may be fourteen months and calendar tracking data 54 of vacuum pump XYZ may be two months and twenty-seven days. Thus, the threshold for recommending lubricating the drive and bearings of a vacuum pump every fourteen months is not met since calendar tracking data 54 for lubricating the drive and bearings of vacuum pump XYZ is only two months and twenty-seven days.

Maintenance module 48 may also compare usage tracking data 55 to usage maintenance data 53 for a particular maintenance task for a particular instance of equipment 18 to determine if usage tracking data 55 associated with a particular maintenance task for a particular instance of equipment 18 equals or exceeds usage maintenance data 53 for that particular type of equipment 18. For example, usage maintenance data 53 for lubricating the drive and bearings of a vacuum pump may be 1,500 hours. Thus, the threshold for recommending lubricating the drive and bearings of a vacuum pump every 1,500 hours is met since usage tracking data 55 indicates that vacuum pump XYZ has been in use for 1,510 hours since lubricating the drive and bearings of vacuum pump XYZ was last performed.

In response to either threshold being met, maintenance module 48 may generate an alert associated with a recommendation to perform the particular maintenance task for the particular instance of equipment 18. In some embodiments, maintenance module 48 may generate the alert based on the alert data 46 stored in memory 40. For example, maintenance module 48 may email two particular users 28 to recommend lubricating the drive and bearings of vacuum pump XYZ because it has been in use for 1,510 hours since this maintenance task was last performed. After a user 28 performs the recommended maintenance task for the particular instance of equipment, as described in the alert, the user 28 may use GUI 34 to indicate that the recommended maintenance task has been performed on the particular instance of equipment 18. In response, maintenance module 48 may reset to zero the accumulated time data associated with calendar tracking data 54, and usage tracking data 55 associated with the particular maintenance task for the particular instance of equipment 18.

By interacting with GUI 34, user 28 may indicate that a particular maintenance task was performed on a particular instance of equipment 18, the date the particular maintenance task was performed, and who performed the particular maintenance task. By interacting with GUI 34, user 28 may also generate a maintenance summary report based on a specified date range in the past or future. Maintenance summary report may be used to track and manage costs associated with equipment maintenance, which may help owner of system plan a budget.

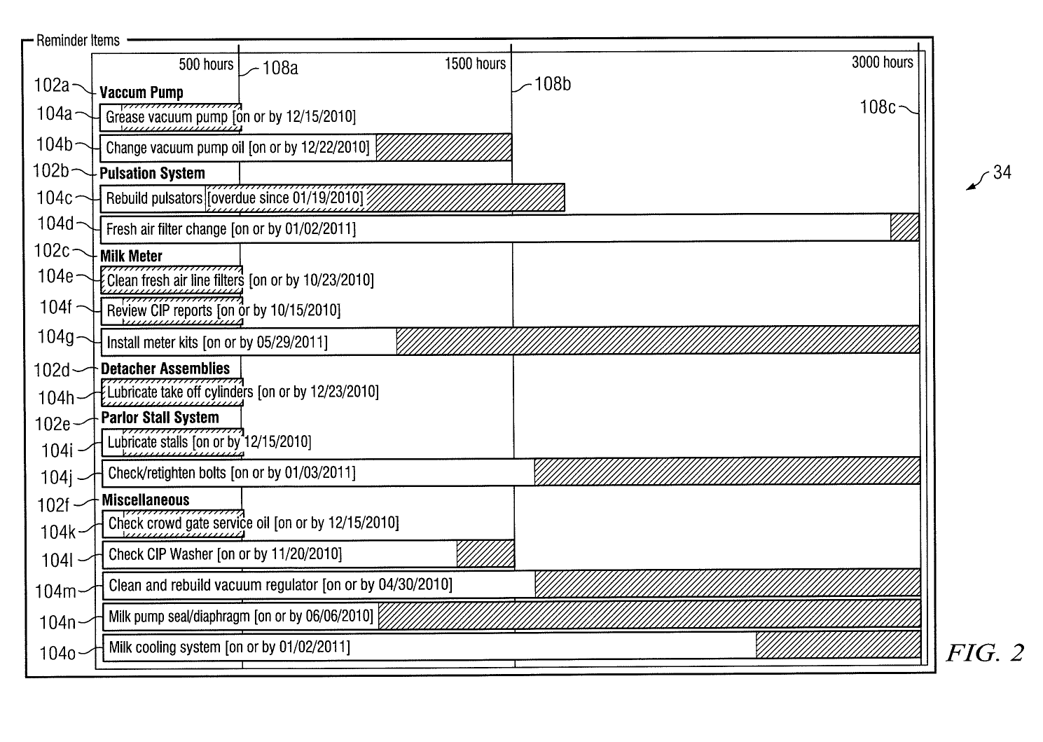

GUI 34 may display a bar chart associated with each maintenance task for each instance of each type of equipment 18. The bar chart may display different colors associated with the urgency of when a particular maintenance task for a particular instance of equipment 18 should be performed. For example, a bar may change from blue to green to yellow to red as the time to perform the particular maintenance task gets closer. Each color displayed may be associated with a predetermined percentage value as to how close in time the maintenance task is to recommended. GUI 34 is described in more detail below in FIG. 2.

One or more embodiments of system 10 may provide important technical advantages. For example, system 10 may provide a central location (or a limited number of distributed locations) for storing each recommended maintenance task for each particular instance of equipment 18 that has been deployed. Another advantage is that system 10 may provide an intelligent display of maintenance information to user 28 for each particular instance of equipment 18 that has been deployed. Another advantage is that system 10 may automatically notify one or more users 28 when to perform each maintenance task for each particular instance of equipment 18 that has been deployed. As a result, users 28 may not need to spend time checking separate manuals for each type of equipment 18 to determine when to perform a particular maintenance task. By performing the recommended maintenance tasks at the recommended time intervals, the equipment 18 may last longer and perform better, which may increase profits and decrease costs associated with fixing broken equipment 18 or buying replacement equipment 18. System 10 may decrease the chance of equipment 18 failure, which may increase safety and performance of users 28 or animals associated with system 10. Particular embodiments of system 10 may provide some, none, or all of the foregoing advantages.

FIG. 2 illustrates an example Graphical User Interface (“GUI”) 34 that assists a user 28 in monitoring equipment maintenance, according to certain embodiments. As described above, client 30 may display GUI 34 to user 28. Each particular instance of equipment 18 represented in this example GUI 34 is referenced as 102a, 102b, 102c, 102d, 102e, and 102f. GUI 34 may also display one or more bar charts 104a-104o associated with various example maintenance tasks. Bar charts 104 may display a description of a particular maintenance task, a visual representation of the percentage of time until a particular maintenance task for a particular instance of equipment is recommended, and a projected date that the particular maintenance task is recommended. Usage tracking data 55 for each maintenance task may be represented by the amount that each bar chart has been filled in. Usage maintenance data 53 for each maintenance task is indicated at 500 hours 108a, 1,500 hours 108b, and 3,000 hours 108c. Thresholds associated with calendar maintenance data 52 for a particular maintenance task are indicated by the date displayed in the bar charts associated with each particular maintenance task. Although not illustrated in FIG. 2, calendar tracking data 54 may be displayed in other embodiments.

By analyzing GUI 34, user 28 may quickly and efficiently analyze information related to maintaining equipment 18 deployed in system 10. For example, GUI 34 notifies user 28 that pulsation system 102b has a recommended task for rebuilding pulsators 104c that is already overdue because the calendar tracking data 54 has met the threshold associated with calendar maintenance data 52. GUI 34 also displays that the usage tracking data 55 associated with the maintenance task of changing the fresh air filter 104d for pulsation system 102b has almost reached its threshold of 3,000 hours.

User 28 may add, revise, or replace information displayed by GUI 34 and save these changes to memory 40. User 28 may choose to input data associated with an unscheduled event that may be a one time event. For example, if parlor stall system 102e breaks and needs replacement with new equipment 18, user 28 may input the cost associated with this one time event. User 28 may also be able to add one or more maintenance tasks, one or more types of equipment 18, one or more costs associated with one or more maintenance tasks, one or more instances of equipment 18, and any other suitable information.

GUI 34 may allow user 28 to input that a particular maintenance task was performed, the date the maintenance task was performed, who performed the maintenance task, and any other notes associated with the maintenance task. GUI 34 includes a search field that allows user 28 to search for relevant data. In some embodiments, GUI 34 may include a sort function that allows user 28 to sort information according to a particular category. GUI 34 may persistently display any maintenance tasks that have reached a predetermined threshold (e.g., 85% usage tracking data 55 of usage maintenance data 53 or 85% calendar tracking data 54 of calendar maintenance data 52 associated with the particular maintenance task).

FIG. 3 illustrates a table 300 comprising example maintenance data 42 for monitoring equipment maintenance, according to certain embodiments. Table 300 provides a central location for storing the usage maintenance data 53 and calendar maintenance data 52 for each recommended maintenance task for each particular type of equipment 18. As a result, users 28 may not need to spend time checking separate manuals for each type of equipment 18 to determine when to perform a particular maintenance task. Table 300 may comprise column 302 for type of equipment, column 304 for a particular maintenance task associated with the type of equipment, column 306 for usage maintenance data 53, column 308 for calendar maintenance data 52, column 310 for cost, and column 312 for notes. Table 300 may comprise rows that store information associated with each particular maintenance task for each particular type of equipment tracked in table 300.

The first row of table 300 indicates that a vacuum pump should be maintained by greasing the vacuum pump every 345 hours of use or every 2 months from the last time that the vacuum pump was greased. The second row of table 300 indicates that the vacuum pump should also be maintained by changing the oil of the vacuum pump every 500 hours of use or every 3 months from the last time that the vacuum pump had its oil changed.

The third row of table 300 indicates that the pulsator system should be maintained by rebuilding the pulsator every 900 hours of use or every 5 months from the last time that the pulsator was rebuilt in the pulsator system. The fourth row of table 300 indicates that the pulsator system should also be maintained by changing the air filter every 1,000 hours of use or every 6 months from the last time that the pulsator system had its air filter changed. The fourth row of table 300 also includes a note that the air filters may need to be changed earlier if dirty. All rows of table 300 include a cost associated with each maintenance task.

Thus, table 300 provides a central location for user 28 to determine the recommended periods for performing each maintenance task for each type of equipment 18 along with the cost of each maintenance task and any notes associated with each maintenance task. The maintenance data 42 stored in table 300 and the tracking data 44 stored in table 400, as described below, may also be used by maintenance module 48 to automatically determine when each maintenance task for each particular instance of equipment 18 should be performed.

FIG. 4 illustrates a table 400 comprising example tracking data 44 for monitoring equipment maintenance, according to certain embodiments. Table 400 provides a central location for storing the usage tracking data 55 and calendar tracking data 54 for each recommended maintenance task for each particular instance of equipment 18. As a result, users 28 may not need to spend time tracking when maintenance should be performed for each particular instance of equipment 18. Table 400 may comprise column 402 for a general location of a particular instance of equipment 18 (e.g., which dairy farm), column 404 for a specific location of the particular instance of equipment 18 (e.g., which parlor), column 406 for the particular instance of equipment 18, column 408 for a particular maintenance task, column 410 for usage tracking data 55, column 412 for calendar tracking data 54, column 414 for cost, and column 416 for notes. Table 400 may comprise rows that store information associated with each particular maintenance task for each particular instance of equipment 18 tracked in table 400.

The first row of table 400 illustrates that vacuum pump 1 is located at dairy farm ABC in parlor XY. The first row also indicates that vacuum pump 1 has been in use for 350 hours since it was last greased and it has been 29 days since it was last greased. The cost associated with greasing vacuum pump 1 may be stored as $1.00. User 28 has also added a note that vacuum pump 1 is rusty, which may put users 28 on notice that there is a problem. The second row of table 400 illustrates that the same vacuum pump 1 located at dairy farm ABC in parlor XY has been in use for 340 hours since the vacuum pump oil was changed and it has been 28 days since the vacuum pump oil was changed. The cost associated with changing the vacuum pump oil for vacuum pump 1 may be stored as $2.50.

The third row of table 400 illustrates that vacuum pump 2 is located at dairy farm ABC in parlor YZ. The third row also indicates that vacuum pump 2 has been in use for 10.3 hours since it was last greased and it has been 25.6 hours since it was last greased. The cost associated with greasing vacuum pump 2 may be stored as $1.00. The fourth row of table 400 illustrates that the same vacuum pump 2 located at dairy farm ABC in parlor YZ has been in use for 340.1 hours since the vacuum pump oil was changed and it has been 22 days since the vacuum pump oil was changed. The cost associated with changing the vacuum pump oil for vacuum pump 2 may be stored as $2.50. User 28 has also added a note that vacuum pump 2 has a belt that is cracking so the belt may need to be replaced.

The fifth row of table 400 illustrates that vacuum pump 3 is located at dairy farm DEF in parlor QQ. The fifth row also indicates that vacuum pump 3 has been in use for 243 hours since it was last greased and it has been 19 days since it was last greased. The cost associated with greasing vacuum pump 3 may be stored as $1.00. The sixth row of table 400 illustrates that the same vacuum pump 3 located at dairy farm DEF in parlor QQ has been in use for 65.6 hours since the vacuum pump oil was changed and it has been 4 days since the vacuum pump oil was changed. The cost associated with changing the vacuum pump oil for vacuum pump 3 may be stored as $2.50.

The seventh row of table 400 illustrates that pulsator system 1 is located at dairy farm ABC in parlor XY. The seventh row also indicates that pulsator system 1 has been in use for 900 hours since the pulsator was last rebuilt and it has been 1 month and 22 days since the pulsator was last rebuilt. The cost associated with rebuilding the pulsator for pulsator system 1 may be stored as $55.75. The eighth row of table 400 illustrates that the same pulsator system 1 located at dairy farm ABC in parlor XY has been in use for 1,050 hours since the air filter was changed and it has been 2 months and 3 days since the air filter was changed. The cost associated with changing the air filter for pulsator system 1 may be stored as $12.00.

Table 400 allows users 28 to keep a history of notes in column 416 that are associated with maintenance tasks for particular instances of equipment 18. The notes found in column 416 in table 400 may allow users 28 to intelligently solve problems associated with equipment maintenance, because the notes may be located at one location. For example, if the rusty vacuum pump 1 is replaced with a new vacuum pump that also becomes rusty, then user 28 may review a history of other notes associated with other instances of equipment 18 located at or around parlor XY to see if these other instances of equipment 18 became rusty. Thus, notes inputted by users 28 at column 416 may indicate a problem of the facilities around the location of parlor XY based on the history of notes inputted by users 28.

As illustrated in table 400, data associated with multiple instances of vacuum pumps located at different remote locations may be stored at a central location. Vacuum pump 1 and 2 may be deployed at dairy farm ABC and vacuum pump 3 may be deployed at dairy farm DEF, but table 400 is able to track information for all three instances of vacuum pumps at a central location.

Thus, table 400 provides a central location for user 28 to monitor the tracking data 44 associated with each maintenance task for each instance of equipment 18 along with the location of each instance of equipment 18, the cost of each maintenance task, and any notes associated with each maintenance task. The maintenance data 42 stored in table 300, as described above, and the tracking data 44 stored in table 400 may also be used by maintenance module 48 to automatically determine when each maintenance task for each particular instance of equipment 18 should be performed.

For example, maintenance module 48 may automatically determine if the maintenance task of greasing vacuum pump 1 should be recommended by determining if the calendar tracking data 54 (29 days) stored in row one, column 412 of table 400 equals or exceeds the calendar maintenance data 52 (2 months) stored in row one, column 308 of table 300, or if usage tracking data 55 (350 hours) stored in row one, column 410 of table 400 equals or exceeds the usage maintenance data 53 (345 hours) stored in row one, column 306. Thus, maintenance module 48 may automatically determine that the maintenance task of greasing vacuum pump 1 should be recommended because its usage tracking data 55 of 350 hours was greater than its usage maintenance data 53 of 345 hours.

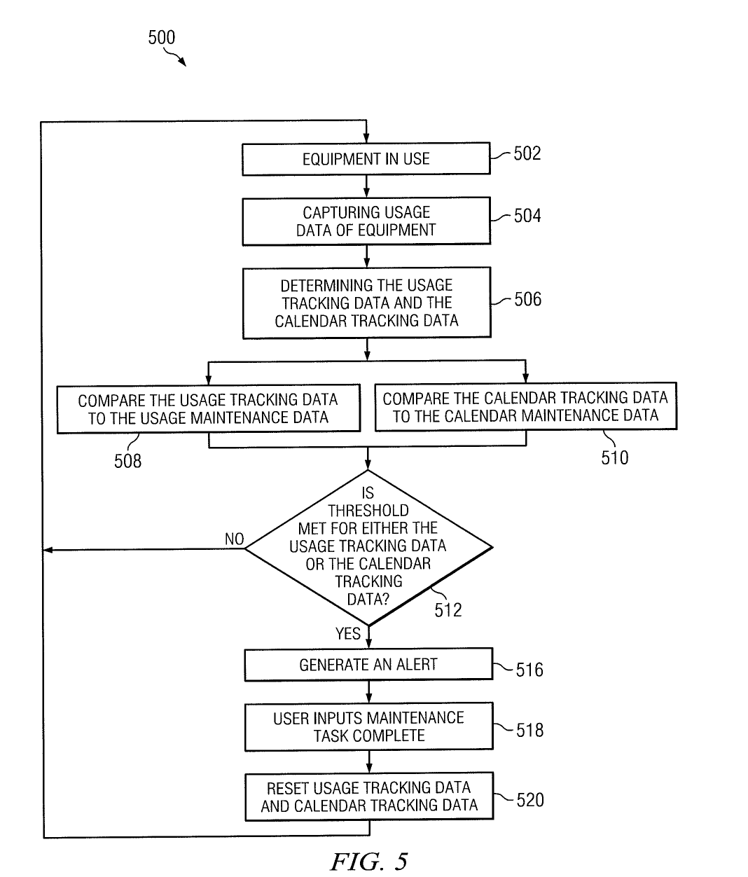

FIG. 5 illustrates a flow diagram 500 for monitoring equipment maintenance, according to certain embodiments. Although flow diagram 500 only describes one piece of equipment 18, flow diagram 500 may be applied for some or all other deployed equipment 18 in parallel, as appropriate. In the illustrated example, the flow diagram 500 begins at step 502 when a particular instance of equipment 18 in use may transmit usage data 20 associated with its period of use. In some embodiments, usage data 20 may comprise time stamps indicating a start and stop time.

At step 504, one or more controllers 22 or one or more clients 30 may capture usage data 20 associated with the particular instance of equipment 18 in use. In some embodiments, the one or more controllers 22 may transmit usage data 20 to the one or more clients 30.

At step 506, maintenance module 48 may determine the usage tracking data 55 and the calendar tracking data 54 for a particular maintenance task associated with the particular instance of equipment 18. In some embodiments, maintenance module 48 may determine usage tracking data 55 for a particular maintenance task associated with a particular instance of equipment 18 by accumulating the time the particular instance of equipment 18 has been in use since the particular maintenance task was last performed. In some embodiments, maintenance module 48 may determine calendar tracking data 54 for a particular maintenance task associated with a particular instance of equipment 18 by accumulating the time since the particular maintenance task was last performed for the particular instance of equipment 18.

At step 508, maintenance module 48 may compare the usage tracking data 55 to the usage maintenance data 53 for a particular maintenance task for a particular instance of equipment 18 to determine if the usage tracking data 55 associated with a particular maintenance task for a particular instance of equipment 18 equals or exceeds a threshold associated with usage maintenance data 53.

At step 510, maintenance module 48 may compare the calendar tracking data 54 to the calendar maintenance data 52 for a particular maintenance task for a particular instance of equipment 18 to determine if the calendar tracking data 54 equals or exceeds a threshold associated with the calendar maintenance data 52.

At step 512, maintenance module 48 may determine if the threshold is met for either the usage tracking data 55 or the calendar tracking data 54 associated with a particular maintenance task for a particular instance of equipment 18. If neither threshold is met, then flow diagram may continue to step 502 because the particular maintenance task for the particular instance of equipment 18 is not recommended yet.

In response to either threshold being met, flow diagram may continue to step 516 to generate an alert to one or more users 28 associated with a recommendation to perform the particular maintenance task for the particular instance of equipment 18. In some embodiments, maintenance module 48 may generate the alert based on the alert data 46 stored in memory 40. User 28 may perform the recommended maintenance task for the particular instance of equipment, as described in the alert.

At step 518, GUI 34 may communicate with maintenance module 48 that the recommended maintenance task has been performed on the particular instance of equipment 18 by user 28. At step 520, maintenance module 48 may reset the accumulated time data associated with the calendar tracking data 54 and usage tracking data 55 associated with the particular maintenance task for the particular instance of equipment to zero. Flow diagram may continue to step 502.

The steps illustrated in FIG. 5 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An equipment maintenance system, comprising:
a memory operable to:
store a plurality of maintenance tasks for a particular type of equipment;
for a particular maintenance task of a particular type of equipment, store maintenance data that comprises at least one of:
calendar maintenance data that is associated with a first period of time since the particular maintenance task was last performed; and
usage maintenance data that is associated with a second period of time that the particular type of equipment has been in use since the particular maintenance task was last performed; and
store tracking data associated with the particular maintenance task for an instance of the particular type of equipment that has been deployed, wherein the tracking data comprises at least one of:
calendar tracking data associated with an accumulated time since the particular maintenance task of the instance of the particular type of equipment was last performed; and
usage tracking data associated with an accumulated time that the instance of the particular type of equipment has been in use since
the particular maintenance task was last performed; and
a processor operable to:
perform at least one of:
determine if the calendar tracking data equals or exceeds a first predetermined threshold associated with the calendar maintenance data; and
determine if the usage tracking data equals or exceeds a second predetermined threshold associated with the usage maintenance data; and
in response to either the first or the second predetermined threshold being met, generate an alert associated with the maintenance task for the instance of the particular type of equipment that has been deployed.

2. The system of claim 1, wherein the memory is further operable to:
store a plurality of types of equipment;
for each particular type of equipment, store a plurality of maintenance tasks; and
for each particular maintenance task, store maintenance data that comprises at least one of calendar maintenance data and usage maintenance data, and tracking data that comprises at least one of calendar tracking data and usage tracking data.

3. The system of claim 1, wherein:
the memory is further operable to store second tracking data associated with the maintenance task for a second instance of the particular type of equipment that has been deployed, wherein the tracking data comprises at least one of:
second calendar tracking data associated with an accumulated time since the particular maintenance task of the second instance of the particular type of equipment was last performed; and
second usage tracking data associated with an accumulated time that the second instance of the particular type of equipment has been in use since the particular maintenance task was last performed; and
the processor is further operable to:
perform at least one of:
determine if the second calendar tracking data equals or exceeds the first predetermined threshold associated with the calendar maintenance data; and
determine if the second usage tracking data equals or exceeds the second predetermined threshold associated with the usage maintenance data; and
in response to either the first or the second predetermined threshold being met, generate a second alert associated with the maintenance task for the second instance of the particular type of equipment that has been deployed.

4. The system of claim 3, wherein the second instance of the particular type of equipment that has been deployed is located at a location remote from the first instance of the particular type of equipment that has been deployed.

5. The system of claim 1, wherein the memory is further operable to:
store additional maintenance data associated with a second particular maintenance task for a particular type of equipment, wherein the additional maintenance data comprises at least one of:
calendar maintenance data, wherein the calendar maintenance data is associated with a first period of time since the particular maintenance task was last performed; and
usage maintenance data, wherein the usage maintenance data is associated with a second period of time that the particular type of equipment has been in use since the second particular maintenance task was last performed.

6. The system of claim 1, wherein the particular type of equipment is associated with a dairy farm.

7. The system of claim 1, wherein the system further comprises a controller, wherein the controller is operable to capture usage tracking data associated with the instance of the particular type of equipment that has been deployed.

8. The system of claim 1, wherein the particular type of equipment comprises at least one of:
a controller;
equipment associated with a vacuum system;
equipment associated with transporting milk;
equipment associated with cleaning;
equipment associated with milking animals;
equipment associated with cooling milk;
equipment associated with identifying animals; and
equipment associated with controlling the crowding of animals.

9. The system of claim 1, further comprising a graphical user interface operable to:
display a percentage for each of the maintenance tasks associated with the instance of the particular type of equipment, wherein the percentage represents the percentage of time until each of the maintenance tasks for the instance of the particular type of equipment is recommended;
display a calendar date associated with when each maintenance task of the instance of the particular type of equipment is recommended;
display an action to be performed by an end user, wherein the action is associated with the maintenance task for the instance of the particular type of equipment;
display costs associated with each maintenance task for the instance of the particular type of equipment; and
receive input from the end user, wherein the received input represents that the maintenance task for the instance of the particular type of equipment was performed.

10. The system of claim 1, wherein the processor is further operable to:
send the alert in one or more emails to one or more recipients;
send the alert in one or more instant messages to one or more recipients; and
send the alert in one or more text messages to one or more recipients.

11. The system of claim 1, wherein the calendar maintenance data comprises at least one of the following units:
years;
months;
days;
hours;
minutes; and
seconds.

12. The system of claim 1, wherein the calendar tracking data comprises at least one of the following units:
years;
months;
days;
hours;
minutes; and
seconds.

13. The system of claim 1, wherein the first predetermined threshold is a user defined percentage of the calendar maintenance data and the second predetermined threshold is a user defined percentage of the usage maintenance data.

14. A method for equipment maintenance, comprising:
storing a plurality of maintenance tasks for a particular type of equipment;
for a particular maintenance task of a particular type of equipment, storing maintenance data that comprises at least one of:
calendar maintenance data that is associated with a first period of time since the particular maintenance task was last performed; and
usage maintenance data that is associated with a second period of time that the particular type of equipment has been in use since the particular maintenance task was last performed; and
storing tracking data associated with the particular maintenance task for an instance of the particular type of equipment that has been deployed, wherein the tracking data comprises at least one of:
calendar tracking data associated with an accumulated time since the particular maintenance task of the instance of the particular type of equipment was last performed; and
usage tracking data associated with an accumulated time that the instance of the particular type of equipment has been in use since the particular maintenance task was last performed; and
performing at least one of:
determining if the calendar tracking data equals or exceeds a first predetermined threshold associated with the calendar maintenance data; and
determining if the usage tracking data equals or exceeds a second predetermined threshold associated with the usage maintenance data; and
in response to either the first or the second predetermined threshold being met, generating an alert associated with the maintenance task for the instance of the particular type of equipment that has been deployed.

15. The method of claim 14, further comprising:
storing a plurality of types of equipment;
for each particular type of equipment, storing a plurality of maintenance tasks. store a plurality of types of equipment; and
for each particular maintenance task, storing maintenance data that comprises at least one of calendar maintenance data and usage maintenance data, and tracking data that comprises at least one of calendar tracking data and usage tracking data.

16. The method of claim 14, further comprising:
storing second tracking data associated with the maintenance task for a second instance of the particular type of equipment that has been deployed, wherein the tracking data comprises at least one of:
second calendar tracking data associated with an accumulated time since the particular maintenance task of the second instance of the particular type of equipment was last performed; and
second usage tracking data associated with an accumulated time that the second instance of the particular type of equipment has been in use since the particular maintenance task was last performed; and
performing at least one of:
determining if the second calendar tracking data equals or exceeds the first predetermined threshold associated with the calendar maintenance data; and
determining if the second usage tracking data equals or exceeds the second predetermined threshold associated with the usage maintenance data; and
in response to either the third or the fourth predetermined threshold being met, generating a second alert associated with the maintenance task for the second instance of the particular type of equipment that has been deployed.

17. The method of claim 16, wherein the second instance of the particular type of equipment that has been deployed is located at a location remote from the first instance of the particular type of equipment that has been deployed.

18. The method of claim 14, further comprising:
storing additional maintenance data associated with a second particular maintenance task for the particular type of equipment, wherein the additional maintenance data comprises at least one of:
calendar maintenance data, wherein the calendar maintenance data is associated with a first period of time since the second particular maintenance task was last performed; and
usage maintenance data, wherein the usage maintenance data is associated with a second period of time that the particular type of equipment has been in use since the second particular maintenance task was last performed.

19. The method of claim 14, wherein the particular type of equipment is associated with a dairy farm.

20. The method of claim 14, further comprising capturing usage tracking data associated with the instance of the particular type of equipment that has been deployed.

21. The method of claim 14, wherein the particular type of equipment comprises at least one of:
a controller;
equipment associated with a vacuum system;
equipment associated with transporting milk;
equipment associated with cleaning;
equipment associated with milking animals;
equipment associated with cooling milk;
equipment associated with identifying animals; and
equipment associated with controlling the crowding of animals.

22. The method of claim 14, further comprising:
displaying a percentage for each of the maintenance tasks associated with the first instance of the particular type of equipment, wherein the percentage represents the percentage of time until each of the maintenance tasks for the instance of the particular type of equipment is recommended;
displaying a calendar date associated with when each maintenance task of the instance of the particular type of equipment is recommended;
displaying an action to be performed by an end user, wherein the action is associated with the maintenance task for the instance of the particular type of equipment;
displaying costs associated with each maintenance task for the instance of the particular type of equipment; and
receiving input from the end user, wherein the received input represents that the maintenance task for the instance of the particular type of equipment was performed.

23. The method of claim 14, further comprising:
sending the alert in one or more emails to one or more recipients;
sending the alert in one or more instant messages to one or more recipients; and
sending the alert in one or more text messages to one or more recipients.

24. The method of claim 14, wherein the calendar maintenance data comprises at least one of the following units:
years;
months;
days;
hours;
minutes; and
seconds.

25. The method of claim 14, wherein the calendar tracking data comprises at least one of the following units:
years;
months;
days;
hours;
minutes; and
seconds.

26. The method of claim 14, wherein the first predetermined threshold is a user defined percentage of the calendar maintenance data and the second predetermined threshold is a user defined percentage of the usage maintenance data.

27. Software for equipment maintenance, the software being embodied in a computer-readable medium and when executed operable to:
store a plurality of maintenance tasks for a particular type of equipment;
for a particular maintenance task of a particular type of equipment, store maintenance data that comprises at least one of:
calendar maintenance data that is associated with a first period of time since the particular maintenance task was last performed; and
usage maintenance data that is associated with a second period of time that the particular type of equipment has been in use since the particular maintenance task was last performed; and
store tracking data associated with the particular maintenance task for an instance of the particular type of equipment that has been deployed, wherein the tracking data comprises at least one of:
calendar tracking data associated with an accumulated time since the particular maintenance task of the instance of the particular type of equipment was last performed; and
usage tracking data associated with an accumulated time that the instance of the particular type of equipment has been in use since the particular maintenance task was last performed; and
perform at least one of:
determine if the calendar tracking data equals or exceeds a first predetermined threshold associated with the calendar maintenance data; and
determine if the usage tracking data equals or exceeds a second predetermined threshold associated with the usage maintenance data; and
in response to either the first or the second predetermined threshold being met, generate an alert associated with the maintenance task for the instance of the particular type of equipment that has been deployed.

28. The software of claim 27, wherein the software is further operable to:
store a plurality of types of equipment;
for each particular type of equipment, store a plurality of maintenance tasks; and
for each particular maintenance task, store maintenance data that comprises at least one of calendar maintenance data and usage maintenance data, and tracking data that comprises at least one of calendar tracking data and usage tracking data.

29. The software of claim 27, wherein the software is further operable to:
store second tracking data associated with the maintenance task for a second instance of the particular type of equipment that has been deployed, wherein the tracking data comprises at least one of:
second calendar tracking data associated with an accumulated time since the particular maintenance task of the second instance of the particular type of equipment was last performed; and
second usage tracking data associated with an accumulated time that the second instance of the particular type of equipment has been in use since the particular maintenance task was last performed; and
perform at least one of:
determine if the second calendar tracking data equals or exceeds the first predetermined threshold associated with the calendar maintenance data; and
determine if the second usage tracking data equals or exceeds the second predetermined threshold associated with the usage maintenance data; and
in response to either the third or the fourth predetermined threshold being met, generate a second alert associated with the maintenance task for the instance of the particular type of equipment that has been deployed.

30. The software of claim 29, wherein the second instance of the particular type of equipment that has been deployed is located at a location remote from the first instance of the particular type of equipment that has been deployed.

31. The software of claim 27, wherein the software is further operable to:
store additional maintenance data associated with a second particular maintenance task for the particular type of equipment, wherein the additional maintenance data comprises at least one of:
calendar maintenance data, wherein the calendar maintenance data is associated with a first period of time since the second particular maintenance task was last performed; and
usage maintenance data, wherein the usage maintenance data is associated with a second period of time that the particular type of equipment has been in use since the second particular maintenance task was last performed.

32. The software of claim 27, wherein the particular type of equipment is associated with a dairy farm.

33. The software of claim 27, wherein the software is further operable to capture usage tracking data associated with the instance of the particular type of equipment that has been deployed.

34. The software of claim 27, wherein the particular type of equipment comprises at least one of:
a controller;
equipment associated with a vacuum system;
equipment associated with transporting milk;
equipment associated with cleaning;
equipment associated with milking animals;
equipment associated with cooling milk;
equipment associated with identifying animals; and
equipment associated with controlling the crowding of animals.

35. The software of claim 27, wherein the software is further operable to:
display a percentage for each of the maintenance tasks associated with the instance of the particular type of equipment, wherein the percentage represents the percentage of time until each of the maintenance tasks for the instance of the particular type of equipment is recommended;
display a calendar date associated with when each maintenance task of the instance of the particular type of equipment is recommended;
display an action to be performed by an end user, wherein the action is associated with the maintenance task for the instance of the particular type of equipment;
display costs associated with each maintenance task for the instance of the particular type of equipment; and
receive input from the end user, wherein the received input represents that the maintenance task for the instance of the particular type of equipment was performed.

36. The software of claim 27, wherein the software is further operable to:
send the alert in one or more emails to one or more recipients;
send the alert in one or more instant messages to one or more recipients; and
send the alert in one or more text messages to one or more recipients.

37. The software of claim 27, wherein the calendar maintenance data comprises at least one of the following units:
years;
months;
days;
hours;
minutes; and
seconds.

38. The software of claim 27, wherein the calendar tracking data comprises at least one of the following units:
years;
months;
days;
hours;
minutes; and
seconds.

39. The method of claim 14, wherein the first predetermined threshold is a user defined percentage of the calendar maintenance data and the second predetermined threshold is a user defined percentage of the usage maintenance data.
